(19) United States
(12) Patent Application Publication
(10) Pub. No.: US 2022/0187547 A1
(43) Pub. Date: Jun. 16, 2022

(54) OPTICAL CONNECTOR AND METHOD FOR MANUFACTURING OPTICAL CONNECTOR

(71) Applicant: Fujikura Ltd., Tokyo (JP)

(72) Inventor: Shuhei Kanno, Sakura-shi (JP)

(73) Assignee: Fujikura Ltd., Tokyo (JP)

(21) Appl. No.: 17/440,026

(22) PCT Filed: May 20, 2020
(86) PCT No.: PCT/JP2020/019969

§ 371 Date: Sep. 16, 2021

(30) Foreign Application Priority Data
Jul. 23, 2019 (JP) 2019-135349

(51) Int. Cl. G02B 6/38

(52) U.S. Cl. CPC G02B 6/38875; G02B 6/3861

(57) ABSTRACT

An optical connector includes: optical fibers including bare portions and covering portions covering the bare portions; a ferrule that accommodates parts of the optical fibers where the bare portions are exposed; a stress relaxation portion that accommodates parts of the optical fibers where the covering portions are formed and relieves a stress acting on the optical fibers; and a boot that has an insertion hole through which the optical fibers are inserted and that connects the ferrule and the stress relaxation portion. The ferrule, the boot, and the stress relaxation portion are separately formed and fixed to each other. The stress relaxation portion includes a constricted portion therein.

### CROSS-REFERENCE TO RELATED APPLICATIONS

This is a national phase application of International Patent Application No. PCT/JP2020/019969 filed May 20, 2020, which claims the benefit of priority to Japanese Patent Application No. 2019-135349, filed Jul. 23, 2019. The full contents of these applications are incorporated herein by reference in their entirety.

### TECHNICAL FIELD

The present invention relates to an optical connector and a method for manufacturing an optical connector.

### BACKGROUND

The optical connector described in Patent Document 1 includes a portion (ferrule) for accommodating a bare portion of an optical fiber, and a boot fixed to the ferrule. The boot includes a head portion to be inserted into the ferrule and a tubular body portion, which are integrally formed. A plurality of cut portions are formed in the tubular body portion, which increases the flexibility of the tubular body portion.

### PATENT DOCUMENT

### Patent Document 1

Japanese Patent No. 5736490

In the configuration described in Patent Document 1, a boot in which a head portion and a tubular body portion are integrated is inserted into a ferrule. Therefore, the optical fiber located on the outer side in the direction in which the optical fibers are arranged may be bent with a large curvature in the ferrule. When the optical fiber is bent with a large curvature in the ferrule, it causes an increase in transmission loss and damage to the optical fiber.

### SUMMARY

The present invention has been made in consideration of such circumstances, and an optical connector is provided that is capable of suppressing bending of an optical fiber with a large curvature in a ferrule.

An optical connector according to one or more embodiments includes a plurality of optical fibers including bare portions and covering portions covering the bare portions; a ferrule that accommodates parts of the plurality of optical fibers in which the bare portions are exposed; a stress relaxation portion that accommodates parts of the plurality of optical fibers in which the covering portions are formed, and relieves a stress acting on the plurality of optical fibers; and a boot including an insertion hole through which the plurality of optical fibers are inserted, and connecting the ferrule and the stress relaxation portion, in which the ferrule, the boot, and the stress relaxation portion are separately formed and fixed to each other, the stress relaxation portion includes a constricted portion therein, and when a lateral direction is a direction in which the plurality of optical fibers are disposed side by side inside the ferrule, and a front side is a side at which the ferrule is located (i.e., positioned) in a longitudinal direction and a rear side is a side at which the stress relaxation portion is located in the longitudinal direction, the width of the constricted portion in the lateral direction of the plurality of optical fibers decreases from the front side toward the rear side.

According to one or more embodiments, it is possible to reduce the curvature of the optical fiber located on the outside in the lateral direction as compared with the case where the constricted portion is disposed inside the ferrule, for example. Therefore, it is possible to prevent the transmission loss from increasing or the optical fiber from being damaged due to bending of the optical fiber with a large curvature. In particular, since the portion of the optical fiber in which the bare portion is exposed is easily damaged, by keeping the portion away from the constricted portion, it is possible to suppress damage to the bare portion.

Further, since the ferrule, the boot, and the stress relaxation portion are formed as separate bodies and fixed to each other, the constricted portion can be more reliably disposed inside the stress relaxation portion compared with the case where the boot and the stress relaxation portion are integrally formed, for example.

According one or more embodiments, it is possible to provide an optical connector capable of suppressing bending of an optical fiber with a large curvature in a ferrule.

### BRIEF DESCRIPTION OF THE DRAWINGS

FIG. 1 is a perspective view of an optical connector according to one or more embodiments.

FIG. 2 is a perspective view of a single ferrule of FIG. 1.

FIG. 3 is a cross-sectional view taken along line III-III of FIG. 1.

FIG. 4 is a perspective view of a single boot of FIG. 1.

FIG. 5A is a diagram illustrating a method for manufacturing an optical connector according to one or more embodiments.

FIG. 5B is a diagram illustrating a step following FIG. 5A.

FIG. 5C is a diagram illustrating a step following FIG. 5B.

FIG. 6 is a cross-sectional view taken along line VI-VI of FIG. 1.

### DETAILED DESCRIPTION

Hereinafter, an optical connector and a method for manufacturing an optical connector according to one or more embodiments will be described with reference to the drawings.

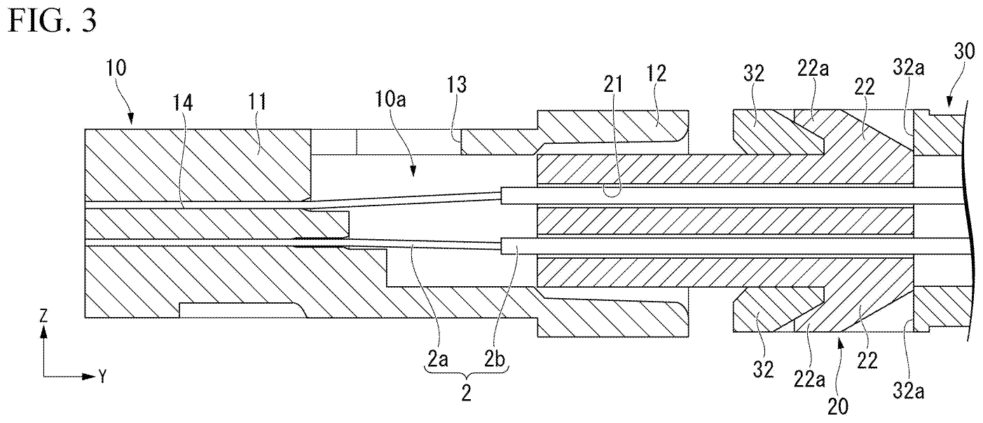

As shown in FIG. 1, an optical connector 1 includes a plurality of optical fibers 2, a ferrule 10, a boot 20, a stress relaxation portion 30, and a protect tube 3. The ferrule 10, the boot 20, and the stress relaxation portion 30 are separate bodies. The optical fiber 2 includes a bare portion 2a and a covering portion 2b (see FIG. 3). The bare portion 2a includes a core and a clad (not shown), and is formed of glass or the like. The covering portion 2b covers the bare portion 2a and is formed of a resin or the like. The ferrule 10 is a so-called MT ferrule, and the optical connector 1 is a so-called MT type optical connector.

(Direction Definition)

In one or more embodiments, the XYZ Cartesian coordinate system is set and the positional relationship between components is described. The X-axis direction is the direction in which a plurality of optical fibers 2 are arranged inside the ferrule 10. The Y-axis direction is the direction in which the optical fiber 2 extends inside the ferrule 10. The Z-axis direction is a direction orthogonal to both the X-axis direction and the Y-axis direction. Hereinafter, the X-axis direction is referred to as a lateral direction X, the Y-axis direction is referred to as a longitudinal direction Y, and the Z-axis direction is referred to as an up-down direction Z. In the longitudinal direction Y, the side on which the ferrule 10 is located is referred to as a front side, and the side on which the stress relaxation portion 30 is located is referred to as a rear side.

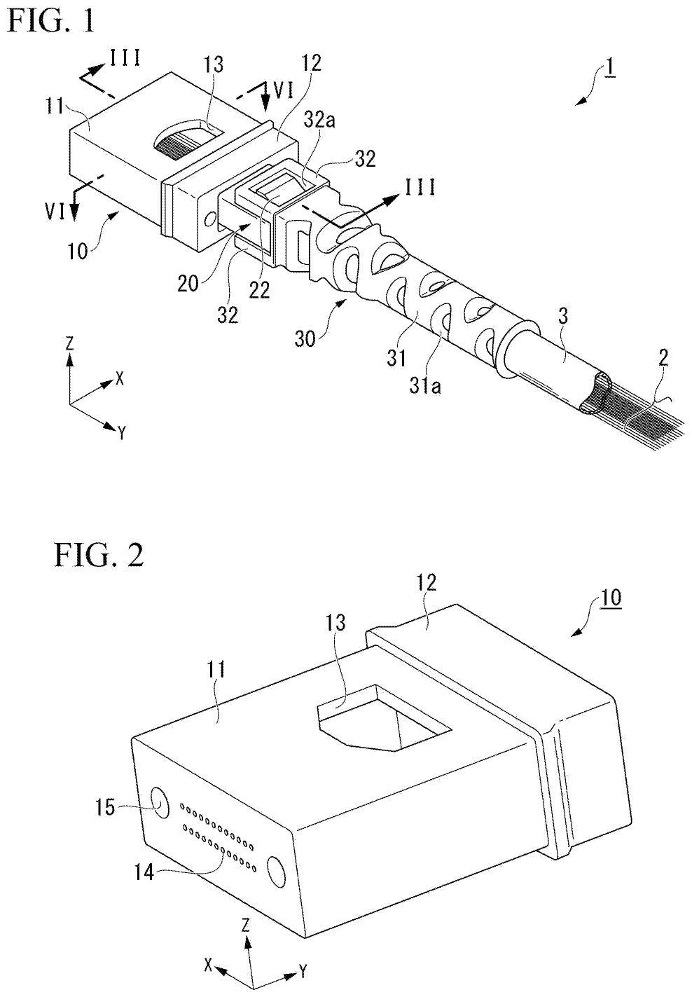

The ferrule 10 is made of a hard resin. The ferrule 10 accommodates parts of the optical fibers 2 in which the bare portions 2a are exposed. As shown in FIG. 2, the ferrule 10 includes a main body portion 11 and a wide portion 12. The wide portion 12 has larger dimensions in the lateral direction X and the up-down direction Z than the main body portion 11. The main body portion 11 and the wide portion 12 are integrally formed. When viewed from the longitudinal direction Y, the main body portion 11 and the wide portion 12 are formed in a rectangular shape in which the dimension in the lateral direction X is larger than the dimension in the up-down direction Z.

A plurality of through holes 14 extending along the longitudinal direction Y are formed in the main body portion 11. Each through hole 14 is a region into which the bare portion 2a of the optical fiber 2 is inserted. The plurality of through holes 14 are disposed side by side in the lateral direction X, and the through holes are disposed in a plurality of rows in the up-down direction Z. In FIG. 2, the number of the through holes 14 arranged in the lateral direction X is twelve, and the through holes are lined up in two rows. That is, the ferrule 10 of one or more embodiments is capable of accommodating 24 optical fibers 2. The number and arrangement of the through holes 14 may be changed as appropriate. As shown in FIG. 3, in each through hole 14, a tapered surface for facilitating the insertion of the bare portion 2a is formed in the opening that opens toward the rear side.

As shown in FIG. 2, two positioning portions 15 are formed on the front end surface of the main body portion 11. The two positioning portions 15 are disposed so as to sandwich a plurality of through holes 14 in the lateral direction X. The positioning portions 15 are used to determine the positions of the connectors when the optical connector 1 is connected to another optical connector. In FIG. 2, since the positioning portion 15 is a hole, a pin is provided on the mating connector. Alternatively, a pin may be disposed as the positioning portion 15 of the optical connector 1 and a hole may be formed in the mating connector1

A filling hole 13 is formed in the main body portion 11. The filling hole 13 is used to fill an adhesive to the inside of the ferrule 10 (accommodating portion 10a in FIG. 3), when assembling the optical connector 1. In FIG. 3, the filling hole 13 is formed only on the upper surface of the main body portion 11, but the filling hole 13 may be formed on the lower surface of the main body portion 11. Alternatively, the filling holes 13 may be formed on the upper surface and the lower surface of the main body portion 11, respectively.

As shown in FIG. 3, a hollow region is formed in the ferrule 10. The inside region of the ferrule 10 is an accommodating portion 10a that accommodates parts of the optical fibers 2 and a part of the boot 20. The accommodating portion 10a is opened toward the rear side. The optical fibers 2 and the boot 20 are inserted into the accommodating portion 10a through the opening positioned in the rear side of the accommodating portion 10a. Further, the filling hole 13 is connected to the accommodating portion 10a. By filling the adhesive through the filling hole 13, the optical fibers 2 and the boot 20 are fixed to the ferrule 10.

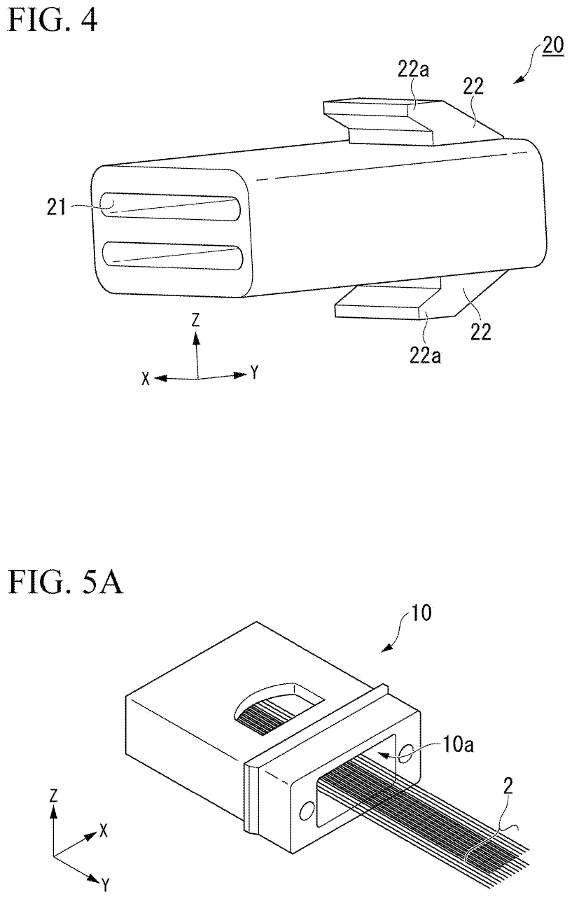

The boot 20 is made of a material softer than the ferrule 10, such as rubber. By press-fitting the boot 20 made of a soft material into the ferrule 10, it is possible to prevent the adhesive leaking from the gap between the boot 20 and the ferrule 10. As shown in FIG. 4, an insertion hole 21 that passes through the boot 20 in the longitudinal direction Y is formed in the boot 20. In one or more embodiments, since the through holes 14 of the ferrule 10 are arranged in two rows, two insertion holes 21 are formed in the boot 20 in accordance with this.

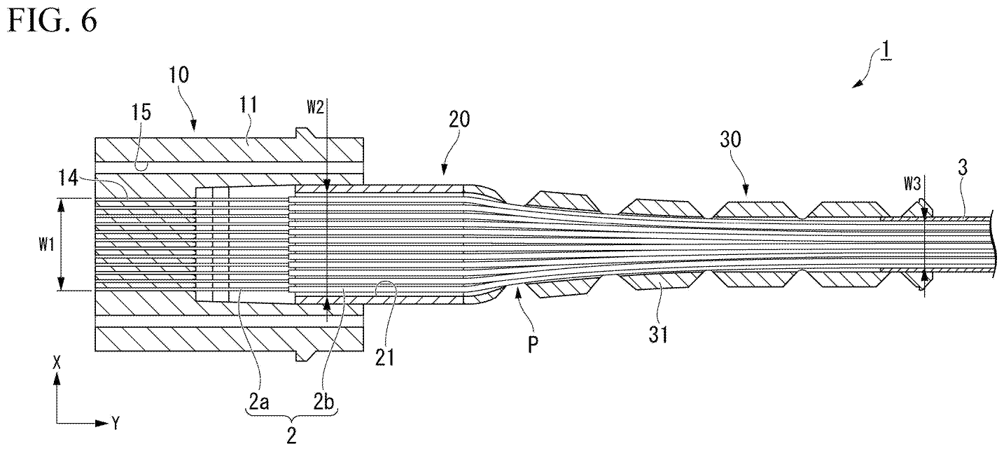

The two insertion holes 21 are elongated holes extending in the lateral direction X when viewed from the longitudinal direction Y. Further, the two insertion holes 21 are disposed at intervals in the up-down direction Z. In the example shown in FIGS. 3 and 6, the insertion holes 21 accommodates parts of the optical fibers 2 in which the covering portions 2b are formed. Since the optical connector 1 of one or more embodiments includes 24 optical fibers 2, half (12) of the optical fibers 2 are inserted into the upper insertion hole 21, and the other half (12) of the optical fibers 2 are inserted into the lower insertion hole 21. The width W2 of the insertion hole 21 in the lateral direction X is larger than the width W1 of the region provided with the plurality of through holes 14 in the ferrule 10 in the lateral direction X (see FIG. 6).

As shown in FIG. 4, the boot 20 is formed with two first engaging portions 22. One of the first engaging portions 22 projects from the upper surface and the other first engaging portion 22 projects from the lower surface of the boot 20. Further, each of the first engaging portions 22 is formed with a protruding portion 22a projecting toward the front side. The first engaging portion 22 is used to engage the stress relaxation portion 30 with the boot 20.

The stress relaxation portion 30 is made of a material softer than the ferrule 10, such as rubber. The stress relaxation portion 30 accommodates parts of the optical fibers 2 in which the covering portions 2b are formed. As shown in FIG. 1, the stress relaxation portion 30 includes a flexible portion 31 and two second engaging portions 32. The flexible portion 31 is formed in a cylindrical shape extending along the longitudinal direction Y. A plurality of cut portions 31a are formed in the flexible portion 31, which increases the flexibility. Because of the flexibility of the flexible portion 31, it is possible to suppress the action of local bending or stress on the optical fiber 2. That is, the stress relaxation portion 30 relieves the stress acting on the optical fiber 2.

A protect tube 3 is fixed to the rear end of the flexible portion 31. The protect tube 3 covers and protects parts of the optical fibers 2 located behind the stress relaxation portion 30. Although, in FIG. 1, a part of the protect tube 3 is not described to show the optical fiber 2, the protect tube 3 extends toward the rear side from the stress relaxation portion 30. The inner diameter W3 of the protect tube 3 is smaller than the above-described widths W1 and W2 (see FIG. 6).

As shown in FIG. 1, the two second engaging portions 32 are provided at the front end portions of the stress relaxation portion 30. The two second engaging portions 32 are formed so as to sandwich the boot 20 in the up-down direction Z. Further, an engaging hole 32a is formed in each of the second engaging portions 32. As shown in FIG. 3, the first engaging portion 22 enters the inner side of the engaging hole 32a, and the protruding portion 22a overlaps with the second engaging portion 32. In this way, the stress relaxation portion 30 is fixed to the boot 20 by engaging the first engaging portion 22 with the second engaging portion 32.

Although not shown, in one or more embodiments, the boot 20 and the stress relaxation portion 30 are fixed by an adhesive in order to increase the fixing strength therebetween. The fixing position using the adhesive may be changed as appropriate. For example, in the state shown in FIG. 1, the engaging hole 32a may be filled with the adhesive.

Further, the shapes of the first engaging portion 22 and the second engaging portion 32 may be appropriately changed as long as they are engaged with each other. For example, recesses (first engaging portions) may be provided on the upper and lower surfaces of the boot 20, and protruding portions (second engaging portions) that engage with these recesses may be provided in the stress relaxation portion 30.

Next, an example of a method for manufacturing the optical connector 1 will be described. The manufacturing method to be described below is only an example and may be changed as appropriate.

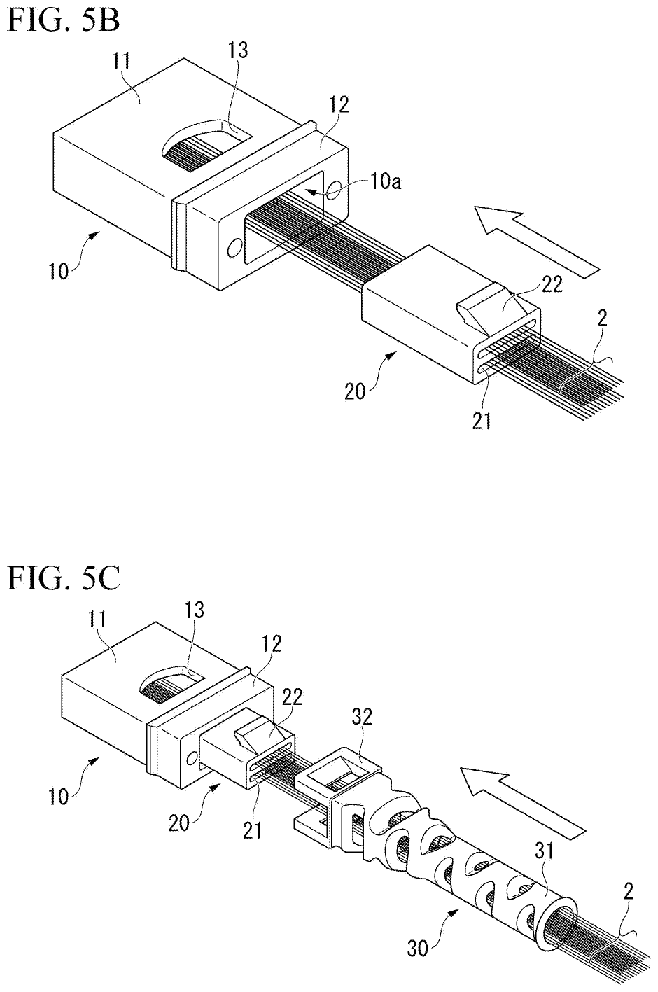

First, the covering portions 2b at the tip of the optical fibers 2 are removed to expose the bare portions 2a. Next, as shown in FIG. 5A, the optical fibers 2 are inserted into the accommodating portion 10a of the ferrule 10. In this case, each bare portion 2a is inserted into each through hole 14 of the ferrule 10. Although not shown in FIG. 5A, the optical fibers 2 may be inserted into the boot 20, the stress relaxation portion 30, and the protect tube 3 before inserting the optical fibers 2 into the accommodating portion 10a.

Next, as shown in FIG. 5B, the boot 20 is inserted into the accommodating portion 10a of the ferrule 10 in a state where the optical fibers 2 are inserted in the insertion holes 21. Next, the adhesive is filled through the filling hole 13 of the ferrule 10. In this case, the adhesive also enters the insertion holes 21 from the opening positioned in the front side of the insertion holes 21, in the accommodating portion 10a. Therefore, when the adhesive is cured, the optical fibers 2 are fixed in the accommodating portion 10a and in the insertion holes 21.

Next, as shown in FIG. 5C, the stress relaxation portion 30 is brought closer to the boot 20 from behind in a state where the optical fibers 2 are inserted inside the stress relaxation portion 30. Next, the first engaging portion 22 and the second engaging portion 32 are engaged with each other. Next, the boot 20 and the stress relaxation portion 30 are adhesively fixed to each other with an adhesive. Then, the protect tube 3 is fixed to the stress relaxation portion 30. Thus, the optical connector 1 as shown in FIG. 1 is obtained.

According to the manufacturing method as described above, the optical fibers 2 are adhesively fixed in the insertion holes 21 of the boot 20, and thereafter the stress relaxation portion 30 is attached to the boot 20. Here, the width W2 of the insertion hole 21 in the lateral direction X is larger than the width W1 of the region provided with the plurality of through holes 14 in the ferrule 10 in the lateral direction X. Therefore, as shown in FIG. 6, a plurality of optical fibers 2 extend substantially in parallel in the ferrule 10 and the boot 20.

In the front side of the flexible portion 31, the inner diameter (width in the lateral direction X) of the flexible portion 31 of the stress relaxation portion 30 is larger than the width W1 in the lateral direction X of the region provided with the plurality of through holes 14 in the ferrule 10. And, the inner diameter of the flexible portion 31 of the stress relaxation portion 30 gradually decreases toward the rear side. Therefore, the width of the bundle of the optical fibers 2 in the lateral direction X decreases from the front side toward the rear side inside the stress relaxation portion 30. That is, a constricted portion P having a narrow width in the lateral direction of the plurality of optical fibers 2 is disposed inside the stress relaxation portion 30.

The width of the constricted portion P in the lateral direction X may be, for example, the same as the width W2 in the lateral direction X of the insertion hole 21 in the front side. And the width of the constricted portion P in the lateral direction X may be, for example, the same as the inner diameter W3 of the protect tube 3 in the rear side. Further, the width of the constricted portion P in the lateral direction X may be gradually narrowed toward the rear side, or may be narrowed step by step.

Further, as shown in FIG. 6, in the longitudinal direction Y, the length of the constricted portion P may be longer than the length of the through hole 14 of the ferrule 10. Thereby, it is possible to further reduce the curvature of the optical fiber 2 located on the outer side in the lateral direction X.

As described above, the optical connector 1 of one or more embodiments includes a ferrule 10 that accommodates parts of the plurality of optical fibers 2 in which the bare portions 2a are exposed, a stress relaxation portion 30 that accommodates parts of the optical fibers 2 in which the covering portions 2b are formed, and relieves a stress acting on the optical fibers 2, and a boot 20 including an insertion hole 21 through which the optical fibers 2 are inserted, and connecting the ferrule 10 and the stress relaxation portion 30. The ferrule 10, the boot 20, and the stress relaxation portion 30 are formed as separate bodies and are fixed to each other. The stress relaxation portion 30 includes a constricted portion P therein, and the width of the constricted portion P in the lateral direction X of the plurality of optical fibers 2 decreases from the front side toward the rear side.

According to such a configuration, it is possible to reduce the curvature of the optical fiber 2 located on the outer side in the lateral direction X, as compared with the case where the constricted portion P is disposed inside the ferrule 10, for example. Therefore, it is possible to prevent the transmission loss from increasing or the optical fiber 2 from being damaged due to bending of the optical fiber 2 with a large curvature. In particular, since the part in which the bare portion 2a is exposed is easily damaged, by keeping the part away from the constricted portion P, it is possible to suppress damage to the bare portion 2a. Further, since the ferrule 10, the boot 20, and the stress relaxation portion 30 are formed as separate bodies and fixed to each other, the constricted portion P can be more reliably disposed inside the stress relaxation portion 30, compared with the case where the boot 20 and the stress relaxation portion 30 are integrally formed, for example.

Further, the first engaging portion 22 may be formed in the boot 20, and the second engaging portion 32 that engages with the first engaging portion 22 may be formed in the stress relaxation portion 30. According to this configuration, the boot 20 and the stress relaxation portion 30, formed as separate bodies, can be easily fixed.

Further, the ferrule 10 and the boot 20 may be adhesively fixed to each other by an adhesive, and the boot 20 and the stress relaxation portion 30 may be adhesively fixed to each other by the adhesive. With this configuration, it is possible to firmly fix the ferrule 10, the boot 20, and the stress relaxation portion 30.

Further, in the front side of the constricted portion P, the width of the constricted portion P in the lateral direction X may be larger than the width W1 in the lateral direction X of the region provided with the plurality of through holes 14 in the ferrule 10. And the width of the constricted portion P in the lateral direction X may decrease toward the rear side. Thus, in the ferrule 10 and the boot 20, the plurality of optical fibers 2 can be in a state of extending substantially in parallel, so that it is possible to reliably suppress damage to the bare portion 2a. Further, it is possible to reduce the curvature of the optical fiber 2 located on the outer side in the lateral direction X.

Further, the width W2 of the insertion hole 21 of the boot 20 in the lateral direction X may be larger than the width W1 in the lateral direction X of the region provided with the plurality of through holes 14 in the ferrule 10. With this configuration, it is possible to further reduce the curvature of the optical fiber 2 located on the outside in the lateral direction X.

Further, the manufacturing method for an optical connector method of one or more embodiments includes adhesively fixing parts of the plurality of optical fibers 2 in which the bare portions 2a are exposed to the inside of the ferrule 10, adhesively fixing the boot 20 to the ferrule 10, in a state where the plurality of optical fibers 2 are inserted into the insertion hole 21 of the boot 20, and fixing the stress relaxation portion 30 to the boot 20, in a state where the plurality of optical fibers 2 are inserted into the stress relaxation portion 30. By this manufacturing method, it is possible to assemble the optical connector 1 in which the constricted portion P is disposed inside the stress relaxation portion 30.

It should be noted that the technical scope of the present invention is not limited to the above-described embodiments, and various modifications can be made without departing from the spirit of the present invention.

For example, in one or more embodiments, two insertion holes 21 are formed in the boot 20, but the number of insertion holes 21 may be appropriately changed according to the number of rows of the through holes 14 of the ferrule 10.

Further, in one or more embodiments, the stress relaxation portion 30 and the protect tube 3 are separate bodies, but these may be integrally formed.

Further, although a plurality of cut portions 31a are formed in the flexible portion 31 of the stress relaxation portion 30, such cut portions 31a may not be formed.

In addition, without departing from the spirit of the present invention, it is possible to appropriately replace the constituent elements in one or more embodiments with well-known constituent elements, and the above-described embodiments and modification examples may be appropriately combined.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Optical connector

2: Optical fiber

2a: Bare portion

2b: Covering portion

10: Ferrule

20: Boot

22: First engaging portion

30: Stress relaxation portion

32: Second engaging portion

P: Constricted portion

X: Lateral direction

1. An optical connector comprising:
optical fibers comprising bare portions and covering portions covering the bare portions;
a ferrule that accommodates parts of the optical fibers where the bare portions are exposed;
a stress relaxation portion that accommodates parts of the optical fibers where the covering portions are formed and relieves a stress acting on the optical fibers; and
a boot that has an insertion hole through which the optical fibers are inserted and that connects the ferrule and the stress relaxation portion, wherein
the ferrule, the boot, and the stress relaxation portion are separately formed and fixed to each other,
the stress relaxation portion comprises a constricted portion therein, and
a width of the constricted portion in a lateral direction of the optical fibers decreases from the front side toward the rear side in a configuration where the ferrule accommodates the optical fibers side by side in the lateral direction, the ferrule is positioned at a front side in a longitudinal direction and the stress relaxation portion is positioned at a rear side in the longitudinal direction.

2. The optical connector according to claim 1, wherein
the boot comprises a first engaging portion, and
the stress relaxation portion comprises a second engaging portion that engages with the first engaging portion.

3. The optical connector according to claim 1, wherein
the ferrule and the boot are adhesively fixed to each other with an adhesive, and
the boot and the stress relaxation portion are adhesively fixed to each other with the adhesive.

4. The optical connector according to claim 1, wherein
in the front side of the constricted portion, the width of the constricted portion in the lateral direction is larger than a width in the lateral direction of a region having through holes for accommodating the plurality of optical fibers in the ferrule, and
the width of the constricted portion in the lateral direction decreases toward the rear side.

5. The optical connector according to claim 1, wherein
a width of the insertion hole of the boot in the lateral direction is larger than a width in the lateral direction of a region having through holes for accommodating the optical fibers in the ferrule.

6. A method for manufacturing an optical connector, the method comprising:
adhesively fixing parts of optical fibers, where bare portions are exposed, to an inside of a ferrule;
adhesively fixing a boot to the ferrule, such that the optical fibers are inserted into an insertion hole of the boot; and
fixing a stress relaxation portion to the boot such that the optical fibers are inserted into the stress relaxation portion.
